(19) United States
(12) Patent Application Publication
(10) Pub. No.: US 2003/0224764 A1
(43) Pub. Date: Dec. 4, 2003

(54) Technique for providing information assistance with restrictions

(76) Inventor: Nathan Bryant Baker, Tigard, OR (US)

Correspondence Address: Alex L. Yip, Kaye Scholer LLP, 425 Park Avenue, New York, NY, 10022, US

(21) Appl. No.: 10/160,557

(22) Filed: May 31, 2002

(51) Int. Cl. G06F 17/60

(52) U.S. Cl. 455/414.1

(57) ABSTRACT

An inventive technique includes receiving via a switch a request from a caller desiring an information assistance service, determining based on one or more criteria whether the information assistance service should be provided, and if it is determined that the information assistance service should not be provided, generating a response to the caller to that effect. The criteria may include whether the caller has bad debts or has satisfied bad debts, whether there is a history of chronic bill disputes, whether there has been abuse of service operators, and how much time has elapsed since a restriction on providing information assistance has been imposed. In accordance with an aspect of the invention, the method includes building an automatic number identification (ANI) restriction table to keep track of calling numbers and restrictions associated with those numbers and based on satisfaction of at least one criterion. The decision to restrict service is then based on searching the ANI restriction table for the calling number. If it is determined that the information assistance service should be provided, a database may be searched for a telephone number associated with the caller's request.

### BACKGROUND OF THE INVENTION

The invention relates generally to a communications system and method. More specifically, the invention relates to a system and method for providing information assistance in a telecommunications environment.

In a typical information assistance call, a caller identifies to an operator the name and address (sometimes city or area code) of a party whose telephone number is desired. In response, the operator locates the desired destination number using, e.g., a computer database. The destination number is then provided to the caller, e.g., by a computerized voice server which provides automated voicing of the number, and the caller is afforded an option to be connected to the destination number without the need of first terminating the information assistance call.

Implementing such an information assistance arrangement effectively requires minimizing impacts to profit margin. The greatest risk to margin, and therefore to profitability, is fraud. Local exchange carriers (LECs) which connect callers to the information assistance service currently manage fraud by restricting access to the information assistance service by classes of calls. These classes may include, e.g., prison calls, payphone calls, and other calls deemed unbillable.

### SUMMARY OF THE INVENTION

It may be helpful that LECs screen calls to an information assistance service based on the aforementioned classes of calls restriction to remove instances of fraud in prior art.

However, such call screening by the LECs removes only a limited number of fraudulent calls to the information assistance service. Since a prior art information assistance service indiscriminately provides assistance to each call forwarded thereto by a carrier, the prior art information assistance service is subject to significant fraud.

I have recognized that prior art fraud control at the LEC level is not sufficient. Thus, in accordance with the invention, the information assistance service itself may institute restrictions on calls received thereby to minimize fraud. These restrictions are, e.g., based on keeping track of individual telephone numbers that access the information assistance service and the behaviors of callers from those numbers. For example, if a caller's behavior does not meet certain requirements, the caller may be denied the information assistance service.

The present invention provides a method for use in a system for providing an information assistance service. The method includes receiving via a carrier network external to the system a communication from a user desiring an information assistance service, determining based on one or more criteria whether the information assistance service should be denied, and if it is determined that the information assistance service should be denied, generating a response to the user concerning the service denial. The criteria may include whether the caller has bad debts or has satisfied bad debts, whether there is a history of chronic bill disputes or frequent requests for service credits, whether there has been abuse of service operators, whether the user's telephone number can be identified, how much time has elapsed since a restriction on providing information assistance has been imposed, and whether ownership of a restricted telephone number has changed. Because the information assistance service provider does not know the identity of the person requesting service, the term “user” includes both the person requesting information assistance and the owner or person responsible for the calling number's telephone line. In accordance with an aspect of the invention, the method includes building a restriction table associated with the user to keep track of restrictions based on the criteria. The restriction table may be identified by automatic number identification (ANI). The decision to restrict service is then based on searching the ANI restriction table for the calling number. In another embodiment, the information assistance service is an operator-assisted service, which may include, for example, collect calling, station-to-station calling, person-to-person calling, or third-party-billed calling services. In accordance with another aspect of the invention, the information assistance service includes a telecommunications relay station, such as may be used by hearing-impaired customers.

If it is determined that the information assistance service should not be denied, the user may be asked to request information assistance, which may include searching a database for a telephone number associated with the caller's request. This database may be accessed via an interface connected to the Internet and may include, e.g., restaurant and/or movie listings.

The system for providing an information assistance service includes a servicing switch for receiving via a carrier network external to the system a communication from a user desiring an information assistance service, a processor for determining based on one or more criteria whether the information assistance service should be denied, and an interface for generating a response to the user concerning a denial of the service if it is determined that the information assistance service should be denied. The interface may include an operator and the information assistance service may be an operator-assisted service.

The present invention allows an information assistance service center to reduce fraud by refusing to provide information assistance service to callers who satisfy one or more of a set of criteria. This is an improvement over the prior art which merely restricted some calls at the LEC level based on the class of telephone from which the information assistance service was requested. In addition, previously restricted callers may be later provided service based on other criteria or a change in the criteria which led to the original restriction.

Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates a system for restricting the provision of an information assistance service in accordance with an embodiment of the present invention;

FIG. 2 illustrates an information assistance service provider and a servicing platform for providing an information assistance service; and

FIG. 3 is a flowchart depicting a routine for determining the provision of information assistance service in accordance with an embodiment of the present invention.

### DETAILED DESCRIPTION

The present invention is directed to providing an information assistance service to such users as wireline (landline) telephone, wireless telephone, and other communications device users. The service of the present invention allows an information assistance service provider to refuse service to certain calls based upon criteria associated with the calling number.

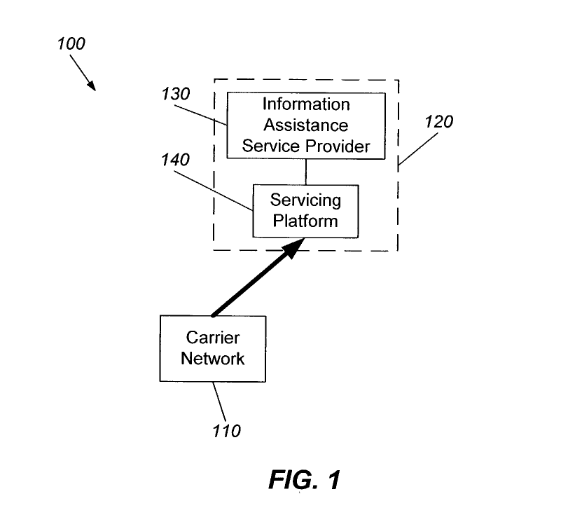

FIG. 1 illustrates an information assistance system embodying the principles of the invention. In this illustrative arrangement, users of a particular telephone carrier, e.g., callers, may dial, speak or otherwise communicate predetermined access digits, access codes or retail numbers, or input a predetermined address or URL (uniform resource locator) established by the carrier to access information assistance service provider 130. For example, the predetermined access digits may be “411”, “*555”, “555-1212”, “00”,etc. On learning one such access digit sequence initiated from a caller's communications device, a switching system of the caller's telephone carrier in a conventional manner routes the information assistance call to service provider 130 through a carrier network. In this instance, carrier network 110 switches the call to servicing platform 140, which is associated with service provider 130.

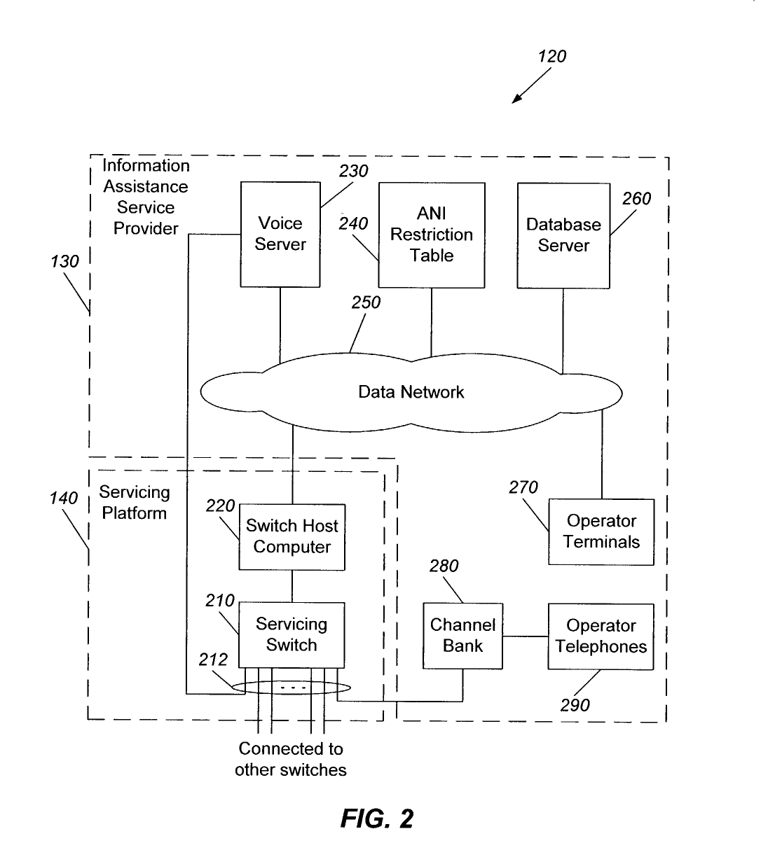

FIG. 2 illustrates information assistance service provider 130 together with servicing platform 140, hereinafter referred to collectively as “information assistance service center 120.” It should be noted that even though both provider 130 and servicing platform 140 appear in the same figure, they may or may not be located in the same geographic area. In FIG. 2, servicing platform 140 comprises servicing switch 210 having T1 spans 212 for connection to voice server 230, channel bank 280, and other switches and networks including, e.g., carrier network 110. In an alternate embodiment, connections may also be made via VoIP (voice over IP (Internet Protocol)), a protocol in which voice information is transmitted in digital form in discrete packets. Servicing switch 210 may receive an incoming information assistance call from a carrier network, e.g., carrier network 110. Servicing switch 210 may also be used to place an outgoing call through a switch which may be different from the carrier network used for the incoming call.

Channel bank 280 in provider 130 is used to couple multiple operator telephones 290 to servicing switch 210. The operators in service center 120 are further equipped with operator terminals 270, each of which includes a video display unit and a keyboard with associated dialing pad. The term “operator” used herein broadly encompasses entities that are capable of providing information assistance in a communication environment, including without limitation human operators, voice response/recognition capabilities, web- or WAP-enabled (“wireless application protocol”) operator services, and other electronic access. Operator terminals 270 are connected over data network 250 to one or more database server(s) 260 (although only one is shown here). Switch host computer 220, voice server 230, and ANI (automatic number identification) restriction table 240 are also connected to data network 250. By way of example, data network 250 includes a local area network (LAN) supplemented by a number of point-to-point data links. Through data network 250 and routers (not shown), components of service center 120 may also be connected to the Internet.

Servicing switch 210 is conventional and supports digital T1 connectivity. The operation of servicing switch 210 is governed by instructions stored in switch host computer 220. In this illustrative embodiment, servicing switch 210 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, dual-tone multi-frequency (DTMF) generators/detectors, or conference units, depending on the demand placed on service center 120 and servicing switch 210 for each corresponding function.

An incoming information assistance call from a caller is received by servicing switch 210 in service center 120 which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 220 or elsewhere in service center 120. In other instances, other distribution logic schemes may be utilized, such as skills-based routing or a priority scheme for preferred callers.

Operators may use database server 260 to provide information assistance including searching for a caller's desired party and determining the appropriate destination number of the party. Other information assistance concerning restaurant recommendations, movie listings, events, etc. may also be provided by searching database server 260. Such database information may also be retrieved using the Internet.

Voice server 230 is used to play the constant repeated parts of an operator's speech, namely, the various greetings and signoffs (or closings). Voice server 230 is connected via data network 250 to switch host computer 220 and via one or more T1 spans to servicing switch 210. Voice server 230 may comprise a general purpose computer and one or more voice cards for voice recognition, voice recording and playback, and call progress analysis. At appropriate stages in a call progression, switch host computer 220 initiates a voice path connection between voice server 230 and servicing switch 210 such that the caller, or the caller and the operator, are able to hear whatever pre-recorded speech is played on that connection by voice server 230. Computer 220 then instructs voice server 230, via data network 250, what type of message to play, and passes data parameters that enable voice server 230 to locate the message appropriate to the call state.

Referring also to FIG. 1, the aforementioned information assistance call in this instance is switched by carrier network 110 to servicing switch 210 via an inbound channel of one of T1 spans 212. The inbound channel or link carrying the information assistance call engages an incoming port (not shown) of servicing switch 210.

By way of example, the caller in the instant information assistance call identifies to an operator the name and address (sometimes city or area code) of a party whose telephone number is desired. In response, the operator locates the desired destination number using, e.g., database server 260. The caller then may choose to be connected to the destination number without the need to first terminate the call.

In a prior art information assistance service, the LEC may attempt to reduce fraud by restricting access to classes of phone services, e.g., prison phones, payphones, or other phones deemed unbillable. However, a more thorough job of reducing fraud can be accomplished at the information assistance service level by restricting the provision of information assistance service to callers who have demonstrated a tendency or propensity to commit fraud in the past.

Thus, in accordance with the invention, not every information assistance call that is routed from the carrier network to the information service provider is serviced by the provider. Rather, for example, based on certain criteria described below, host computer 220 determines whether the calling number should be restricted from being provided information assistance service when the caller requests such a service from provider 130. If the calling number is not restricted, information assistance service provider 130 will provide information assistance in a conventional manner. Once the service is provided, the call is routed to the destination or back to the carrier network depending on the caller's preferences.

If the calling number is restricted, information assistance service will be refused. Host computer 220 will then cause voice server 230 to generate a recorded voice response based upon the reason the calling number is restricted, and then the call will be disconnected.

Calling number restriction criteria may be kept in a look-up table or database, e.g., ANI (automatic number identification) restriction table 240. ANI restriction table 240 may include the ANI (i.e., the calling number), a restriction code (e.g., the reason for the restriction), and the name of the line owner.

The restriction criteria based on which host computer 220 determines whether the calling number is restricted will now be described. For example, these criteria may be based on (1) bad debt files; (2) chronic bill disputers; (3) history of abusive calling, etc.

For the first criterion included above, bad debt files, records are generally kept by a third-party billing agent (such as an LEC) as to which customers pay their bills. The calling numbers of those whose accounts are termed “bad debts” are placed into ANI restriction table 240 along with the restriction code for bad debts, and the line owner's name. If service provider 130 performs first-party billing (i.e., has direct customer accounts), service provider 130 could likewise have customers whose accounts are considered “bad debts.”

In some cases, customers may pay their bills, but they often dispute the charges. Criteria for blocking such “chronic disputers” may include, for example, (1) all calls disputed during two consecutive billing cycles, (2) all calls disputed in one billing cycle with ten or more calls involved, or (3) all calls disputed in one billing cycle, no calls disputed in the next billing cycle, and all calls disputed in the following billing cycle. The calling numbers of those “chronic disputers” are placed into ANI restriction table 240 along with the restriction code for chronic disputers and the line owner's name.

A related class of customers are those who chronically request service credits, and whose requests may not routinely appear on the customers' bills. Such credits may be issued, e.g., in accordance with the technique for issuing customer credits in a co-pending, commonly assigned U.S. Patent Application entitled, “System and Method for Issuing Customer Credits for Information Assistance Services,” filed on even date, which is hereby incorporated by reference. The service provider may keep track of such customers by their ANI. Once the frequency of requests (e.g., five credit requests per month) or the percentage of requests (e.g., 25% of calls requesting credit) crosses certain thresholds, a restriction may be placed in the ANI restriction table for that ANI.

In other cases, customers may be abusive to the information assistance operators, and their calls will be refused. The calling numbers of these abusive customers are placed into ANI restriction table 240 along with the restriction code for abusive customers and the line owner's name.

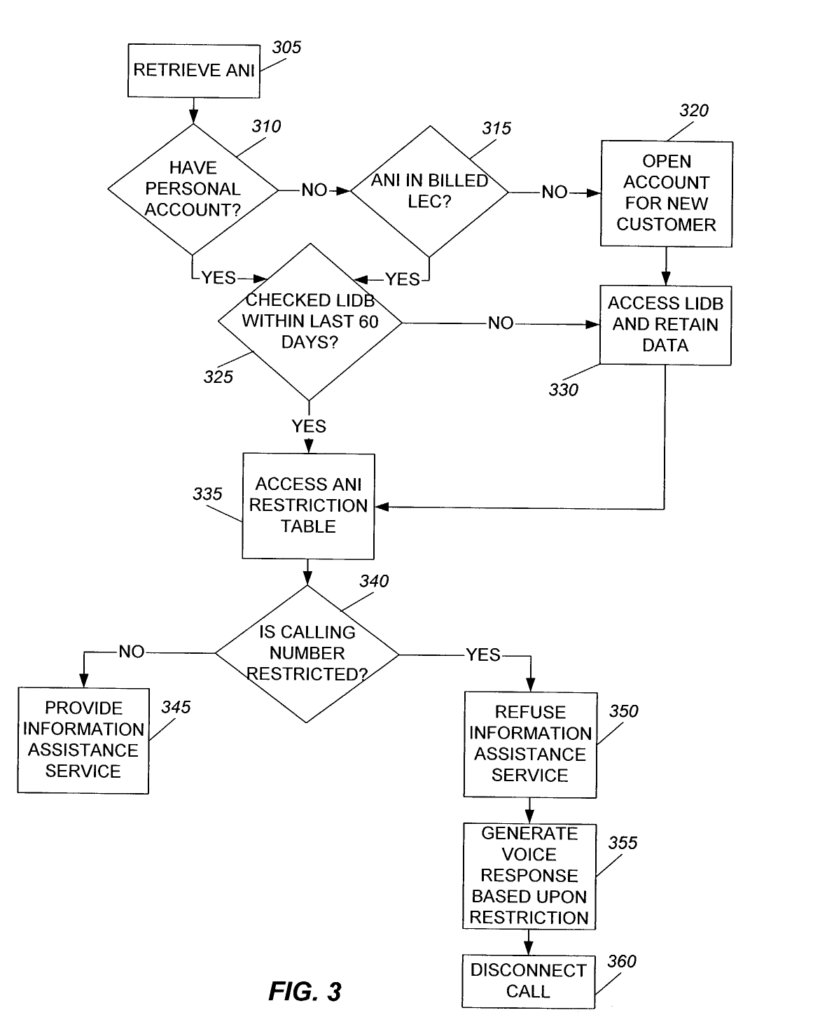

FIG. 3 is a flowchart depicting a routine for determining the provision of information assistance service. In receiving an information assistance call from switch 110, servicing switch 210 also receives call set-up signals containing such data as the caller's ANI, a dialed number identification string (DNIS) for identifying the dialed telephone number, the area of the call's origination site, etc. This information is denoted in step 305. In a preliminary step, service provider 130 makes sure that the calling number has been or can be tracked for billing purposes. This requires the calling number to either have a personal account with information service provider 130 (step 310) or reside within a billable LEC or CLEC (competitive LEC) (step 315). If none of those conditions exist (i.e., the answer to both questions is “no”), information service provider 130 in step 320 will open a new account for the calling number. If either of those conditions exists, the process in step 325 will then see if information service provider 130 has checked a third-party-supplied line information database (LIDB) within the last 60 days. An LIDB may contain subscriber information such as a service profile, billing specifications, billing name and address, and credit card information. The LIDB can be accessed, for example, via database server 260 in FIG. 2. If the LIDB has been checked within the last 60 days, there is no need to check it again. If, however, it has been more than 60 days since the LIDB has been checked or if an account has just been opened for a new customer, step 330 will access the LIDB and retain certain of the data found there (including billing telephone number and billing name and address).

Once the LIDB data is retrieved, in step 335 host computer 220 looks up the ANI in ANI restriction table 240. If the ANI is not found (step 340), the calling number is not restricted, and information assistance is provided in step 345, which may include routing the call to the destination. If the ANI is found in step 340, the calling number is deemed restricted. In step 350, service provider 130 will refuse to provide information assistance service and in step 355 computer 220 will cause voice server 230 to generate a voice response. This voice response may be a general response such as “this service is unavailable for this line” or it may be more restriction-dependent, e.g., a more specific voice response explaining the reason for the refusal of service and possibly including a service number the customer can contact to rectify the situation. In step 360, service provider 130 disconnects the call.

In accordance with the invention, just as restrictions can be placed on calling numbers based on a number of criteria, restrictions can be removed based on other criteria. Such criteria may be, for example, (1) the payment of the bad debt and a current account for a number of months, e.g. three to six; (2) a period, e.g., three to six months, free from bill disputes; or (3) receipt of letters of apology written to remedy the abusive condition. In addition, a more general restriction removal may be based only on the lapse of time, e.g., six months, in which time the calling number may have been recycled by the LEC. In a more interactive process, the LEC can contact the information assistance service provider with updated listing records, and the information assistance service provider can match the updated listings against the ANI restriction table to remove those calling numbers whose line owners have changed or which have been disconnected.

The foregoing merely illustrates the principles of the invention. It will thus be appreciated that those skilled in the art will be able to devise numerous other arrangements which embody the principles of the invention and are thus within its spirit and scope.

For example, instead of having a standalone ANI restriction table, the restriction table could be part of a more comprehensive customer profile, which normally includes information about the customer's calling preferences and service preferences, generally chosen by the customer, as opposed to restrictions in the ANI restriction table placed upon the customer by service provider 130. Such a customer profile is identified by the ANI and may be accessed in a manner similar to that used to access the ANI restriction table. Customer profiles are described in co-pending, commonly assigned U.S. patent application Ser. No. 10/108,730, filed on Mar. 28, 2002, which is hereby incorporated by reference.

Another modification is that instead of simply disconnecting the call from a caller whose request for information assistance is refused (step 360), if the criterion for refusal of service is a bad debt, service provider 130 may choose to route the call to a collection service to attempt to collect the bad debt. Other redirections are possible, including to a communications authority if the criterion for refusal of service is abuse of operators.

In addition to the criteria listed above, there may be partial restrictions on the provision of information assistance. For example, there may be a restriction against providing information assistance for toll calls, but the service provider may still provide information assistance for local calls. In addition, temporary restrictions may be placed on an account, such as when a credit card's expiration date arrives, and the restriction remains until the expiration date or credit card is updated. In this latter scenario, the operator providing information assistance could be prompted by a message on the operator's video screen to update the caller's billing information. Another partial restriction may arise in the situation where the information assistance provider is not able to determine the origin of the call. The provider detects the ANI, but can not find a reference to the ANI in either the ANI restriction table, a table supplied by the billing LEC, or any other table available to the service provider. Such an ANI has a high potential for fraud. In this case, the call may be routed to a special group of operators specially trained to handle fraudulent calls.

As mentioned previously, those skilled in the art will recognize that information assistance is not limited to directory assistance, but could also include providing information such as location and availability of restaurants, movie theater locations and movie times, travel directions, weather, traffic conditions, and other types of information. The information assistance services also encompass calls serviced by an operator, such as collect calls, station-to-station calls, person-to-person calls, and calls billed to a third-party. Furthermore, service center 120 may be configured as a telecommunications relay station which assists hearing-impaired customers to use telecommunications services. These stations perform speech-to-text and text-to-speech conversion.

Moreover, the invention equally applies regardless of whether feature group D (FGD) type signaling, SS7 out-of-band signaling or other signaling is used for communications between switches in the arrangement of FIG. 1.

Finally, information assistance service center 120 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

As discussed above, additional advantages and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

I claim:

1. A method for use in a system for providing an information assistance service, the system including a processor, the method comprising:
receiving, via a carrier network external to the system, a communication from a user desiring an information assistance service;
determining by the processor whether the information assistance service should be denied based on one or more criteria; and
if it is determined that the information assistance service should be denied, generating a response to the user concerning a denial of the service.

2. The method according to claim 1, wherein one of the criteria comprises the user having bad debts.

3. The method according to claim 1, wherein one of the criteria comprises a history of the user chronically disputing service bills.

4. The method according to claim 1, wherein one of the criteria comprises a history of the user requesting service credits.

5. The method according to claim 1, wherein one of the criteria comprises a history of the user abusing service operators.

6. The method according to claim 1, wherein one of the criteria comprises an unknown origin of the user.

7. The method according to claim 1, wherein one of the criteria comprises satisfaction of a bad debt.

8. The method according to claim 1, wherein one of the criteria comprises a lapse of time since service has been denied.

9. The method according to claim 1, wherein one of the criteria comprises a change in ownership of a telephone number previously denied service.

10. The method according to claim 1, further comprising redirecting the user to a third party if the information assistance service is denied.

11. The method according to claim 1, further comprising building a restriction table associated with the user, wherein the restriction table comprises restrictions based on the one or more criteria.

12. The method according to claim 11, wherein the restriction table is identified by automatic number identification (ANI).

13. The method according to claim 11, wherein the determining comprises searching the restriction table.

14. The method according to claim 1, wherein the information assistance service is an operator-assisted service.

15. The method according to claim 14, wherein the operator-assisted service is selected from the group consisting of collect calling, station-to-station calling, person-to-person calling, and third-party-billed calling.

16. The method according to claim 1, wherein the information assistance system comprises a telecommunications relay station.

17. The method according to claim 1, further comprising eliciting from the user a request for an information assistance service if it is determined that the information assistance service should not be denied.

18. The method according to claim 17, further comprising searching a database for a telephone number associated with the user's request.

19. The method according to claim 18, wherein the database is accessed via an interface connected to the Internet.

20. The method according to claim 18, wherein the database includes restaurant listings.

21. The method according to claim 18, wherein the database includes movie listings.

22. A system for providing an information assistance service, comprising:
a servicing switch for receiving, via a carrier network external to the system, a communication from a user desiring an information assistance service;
a processor for determining whether the information assistance service should be denied based on one or more criteria; and
an interface for generating a response to the user concerning a denial of the service if it is determined that the information assistance service should be denied.

23. The system according to claim 22, wherein one of the criteria comprises the user having bad debts.

24. The system according to claim 22, wherein one of the criteria comprises a history of the user chronically disputing service bills.

25. The system according to claim 22, wherein one of the criteria comprises a history of the user requesting service credits.

26. The system according to claim 22, wherein one of the criteria comprises a history of the user abusing service operators.

27. The system according to claim 22, wherein one of the criteria comprises an unknown origin of the user.

28. The system according to claim 22, wherein one of the criteria comprises satisfaction of a bad debt.

29. The system according to claim 22, wherein one of the criteria comprises a lapse of time since service has been denied.

30. The system according to claim 22, wherein one of the criteria comprises a change in ownership of a telephone number previously denied service.

31. The system according to claim 22, wherein if the information assistance service is denied, the user is redirected to a third party.

32. The system according to claim 22, wherein the interface includes a restriction table which comprises restrictions based on the one or more criteria.

33. The system according to claim 32, wherein the restriction table is identified by automatic number identification (ANI).

34. The system according to claim 32, wherein the restriction table is searched in determining whether the information assistance service should be denied.

35. The system according to claim 22, wherein the interface includes an operator.

36. The system according to claim 35, wherein the information assistance service is an operator-assisted service.

37. The system according to claim 36, wherein the operator-assisted service is selected from the group consisting of collect calling, station-to-station calling, person-to-person calling, and third-party-billed calling.

38. The system according to claim 22, further comprising a telecommunications relay station.

39. The system according to claim 22, wherein the interface includes a database for searching for a telephone number associated with the user's communication if it is determined that the information assistance service should be provided.

40. The system according to claim 39, wherein the interface is connected to the Internet.

41. The system according to claim 39, wherein the database includes restaurant listings.

42. The system according to claim 39, wherein the database includes movie listings.
